(19) United States
(12) Patent Application Publication
(10) Pub. No.: US 2021/0289321 A1
(43) Pub. Date: Sep. 16, 2021

(54) A DEVICE FOR LOCATION BASED SERVICES

(71) Applicant: PHILIPS LIGHTING HOLDING B.V., Eindhoven (NL)

(72) Inventors: STEFAN MARCUS VERBRUGH, EINDHOVEN (NL); RUTGER FRANCISCUS WILHELMUS VAN DER VLEUTEN, MIERLO (NL)

(21) Appl. No.: 16/321,636

(22) PCT Filed: Jul. 11, 2017
(86) PCT No.: PCT/EP2017/067341

§ 371 Date: Jan. 29, 2019

(30) Foreign Application Priority Data
Jul. 29, 2016 (EP) 16181961.0

(51) Int. Cl. H04W 4/02

(52) U.S. Cl. CPC H04W 4/026

(57) ABSTRACT

It is an object of the invention to provide an improved device for location based services. Thereto, the invention provides a device (100) for location based services comprising: a sensor for sensing an orientation (10, 20) of the device (100); a processor for receiving the orientation (10, 20) of the device (100) and for running a first application (111) related to the group of mapping, positioning and navigation and a second application (112) other than the first application (111); a display (600) for displaying output of applications; wherein the processor is arranged for running the first application (111) when the device (100) is in a first orientation (10) and the second application (112) when the device (100) is in a second orientation (20); and wherein, the device (100) is in the first orientation (10) if the display (600) is within 30 degrees of a plane perpendicular to gravity, the device (100) is in the second orientation (20) if the display (600) is within 30 degrees of a plane parallel to gravity.

### FIELD OF THE INVENTION

The invention relates to a device for location based services comprising: a sensor, a display, a processor for running a first application and a second application. The invention further relates to a method for location based services and to a computer program product.

### BACKGROUND OF THE INVENTION

Such a device is known from US2015/0378520A1, in which a system is disclosed that provides a mobile device the ability to switch between different applications, to switch settings in one or more applications, and to output a different graphical user interface (GUI), based on orientation of a mobile device. Such a system may aid a user to switch between open applications and help effectively utilizing the limited amount of screen area to output applications. However, such a system is relatively un-ergonomic for applications related to location based services like mapping, positioning and/or navigation.

### SUMMARY OF THE INVENTION

It is an object of the invention to provide an improved device for location based services. Thereto, the invention provides a device for location based services comprising: a sensor for sensing an orientation of the device; a processor for receiving the orientation of the device and for running a first application related to the group of mapping, positioning and navigation and a second application other than the first application; a display for displaying output of applications; wherein the processor is arranged for running the first application when the device is in a first orientation and the second application when the device is in a second orientation; and wherein, the device is in the first orientation if the display is within 30 degrees of a plane perpendicular to gravity, the device is in the second orientation if the display is within 30 degrees of a plane parallel to gravity.

Such a device may provide, based on the orientation and function of the device, a first application related to the group of mapping, positioning and navigation and an application other than the first. Typically, the orientation of a device for location based services does not affect the technical ability of a device to provide location based services, because signals for enabling location based services are receivable at different orientations (e.g. GPS, Bluetooth). Nevertheless, it is still found in ergonomics that a user may hold such a device perpendicular to gravity (i.e. ‘horizontal’ with respect to gravity) during location based services, e.g. positioning and/or navigation, because a user holding the device may find it more functional to look down onto a location map, as the map on the device will be perpendicular to the length of the user and typically parallel to the surface on which the user locates oneself.

Said device is particularly suitable for use in location based services. Said device may be applied within a handheld device. A device for use in location based services may be applied within: a smartphone, a tablet, a wearable device, smart glasses, a handheld device comprising a detector able to detect signals required for location based services, visualization screens, remote controls, or a multimedia device; because these devices may all be able to provide a functionality related to location based services.

Location based services may comprise functionalities related to mapping, positioning and navigation, or any combinations thereof. Mapping may include the feature of generating a displayable image from topological, geographical, orientation or movement/acceleration data. Mapping may enable positioning. Positioning may include the localization of a device with respect to a known point or a defined set of points. This point and set of points may be beacons or waypoints. The set of points may be related to a two-dimensional map of a space. The map may also be three-dimensional. Positioning may relate to a static representation of a position within a space. Multiple positions within a space and their orientation with respect to each other may also be considered positioning. Positioning and/or mapping may enable navigation. Navigation may relate to the functionality to provide a route between at least two locations. Navigation may also relate to the functionality to orient with respect to a single predefined location or point. Location based services may also comprise simultaneous localization and mapping (SLAM).

Said first and second application may comprise “apps”, which are downloadable and storable on the hardware of a device, and which operate in accordance with a part of the hardware of the device. Such apps may provide the device with a functionality related to location based services. As a result, the implementation of an app may enable a device to be suitable for location based services.

Said first and second application may comprise multiple functions. For example, the first application is related to the group of mapping, positioning and navigation, and thus may be a navigation application which may include the functions of routing, voice-control, location tagging, etc. The functions of an application are typically related to the object of that application. For example, a navigation application may comprise the related function of route planning and the additional function of telephoning during navigating. Thus, a first application may for example be implementing app A related to the group of mapping, positioning and navigation with functions (a), (b) & (c); while the differing second application may for example be implementing app B with functions (a) & (d). Furthermore, an application may also be the implementation of a user interface. Thus the first application may for example be implementing a user interface A with features (v) & (w); while the second application may for example be implementing a user interface B with features (v) & (u).

Said first and second application may also comprise a function of a single more comprehensive application. For example, the first application may be a function S of an app A that is related to the group of mapping, positioning and navigation; while the second application may be a function T other than the first (i.e. S) of the same app A. If a comprehensive app comprises a functionality related to the group of mapping, positioning and navigation, but also other functionalities, the abovementioned distinction between the first and the second application may also be done on function level of the application.

The device according to the invention comprises a first orientation and a second orientation. As mentioned before, the device is in the first orientation if the display is within 30 degrees of a plane perpendicular to gravity and in the second orientation if the display is within 30 degrees of a plane parallel to gravity. Said range (within 30 degree of a plane perpendicular or parallel to gravity, i.e. ‘horizontal’ or ‘vertical’) wherein the display of the device is still within the first or second orientation is referred to as the rotational tolerance.

For example, both orientations may be defined within an X-Y-Z Cartesian coordinate system with the Z-axis in the gravitational direction. The first orientation may be a plane defined by the X and Y-axis, which is the plane perpendicular to gravity, which is thus the plane horizontal relative to gravity. This X-Y plane may have a rotational tolerance of 30 degrees with respect to any of both these axes. The second orientation may be a plane parallel with the Z-axis, which is a plane vertical relative to gravity. Said plane may have a rotational tolerance of 30 degrees out of line with respect to the Z-axis. In ergonomics of using devices, the 90 degrees difference between horizontal and vertical is a well-suited separation between different functions, as the device will not flip over, but will tilt maximally. To be more specific, for the use in location based services, it may be more functional to use a ‘horizontal’ orientation with respect to gravity to provide location based services, because a user may be able to look at a map on the device that is perpendicular to the length of the user and typically parallel to the surface on which the user is provided with location based services. For example: Looking down onto the (horizontal) device, the user may have a top view on a map for navigation, while having a top view on the real world. If the device is hold vertical, the user may still have a top view on the map, while having a side-view on the real world in which the user navigates. The latter situation is undesired ergonomically compared to the former.

Furthermore, considering a local Cartesian coordinate system placed at the center of the device with the Z-axis in gravitational direction, three degrees of freedom exist for orientating the device, which are rotation around the X, Y and Z-axis of said local Cartesian coordinate system. Each degree of freedom comprises a 360 degree range. As mentioned before, the first and second orientation are respectively within 30 degrees with respect to the ‘horizontal’ and ‘vertical’. In the example given above, this indicates that the first orientation may be any plane “horizontal ±30” degrees with respect to the associated axes and the second orientation may be any plane “vertical ±30” degrees out of line with respect to the Z-axis. Said rotational tolerance may also be 25 degrees at most; 20 degrees at most; 10 degrees at most; 5 degrees at most; or 20 degrees at most and 10 degrees at least; or 10 degrees at most and 5 degrees at least; or at most 5 degrees.

As the first orientation and the second orientation cover a rotational range wherein the first and second application are implemented on the device, the rotational range not covered by the first and second orientation may be considered a third orientation. A third application may be implemented when the device is in the third orientation. Said third application may be other than the first. Said third application may be equal to the second application, but may also be other than the second application. It may be advantageous to have the range between the first and second orientation covered by a third unrelated application, which may add value to the functionality of the first and second application. For example, a standby function, information screen or menu application. Alternatively, the second application may be implemented in the third orientation, such that the range over which the second application is implemented is extended, for example such that the rotational tolerance of the second orientation is 60 degrees. This may improve the ergonomics of the device, as there will only be a switch between two applications.

An advantage according to the invention is that an improved device is provided for location based services; because the device is able to provide a first application related to the group of mapping, positioning and navigation when the device is in the first orientation, which is ergonomically an improved orientation for mapping, positioning or navigation, while the device is automatically able to provide another application when the device is switched to a second orientation, because that orientation is ergonomically less suited for orientation for mapping, positioning or navigation. Said first application related to the group of mapping, positioning and navigation application and said second application other than the first application may complement each other advantageously within an improved device for location based services.

Another advantage according to the invention is that the implementation of an application other than the first application related to the group of mapping, positioning and navigation may provide the user with an incentive to tilt the device back to an orientation in which the first application related to the group of mapping, positioning and navigation is more ergonomic. Hence, an improved device for use in location based services is provided.

For example, when a device for location based services, which is providing navigation and is used to indicate a route to a user, the user may hold the device horizontal during navigation, because the map on the device is parallel to the surface on which the user is navigating. This may be more ergonomic in navigation. When the user tilts the device to a vertical positon, the orientation of the device will be less suited, or less ergonomic, for navigation. The device may then switch to a second application other than navigation, such that the second application may complement and add value the navigation application. When the user tilts the device back to horizontal position, a navigation application will continue. In this way, an improved and more functional device is provided for use in navigation, i.e. a location based service.

Said display will facilitate and/or expand the functionality of the device, because each application will have the possibility to output information via a display. The display may be a LCD, CRT, OLED, AMOLED, super AMOLED or Retina. The display may moreover be a touchscreen, a 3-D screen or a holographic display.

Said processor may be arranged for accessing a memory for storing information. As known to the person skilled in the art, the memory may be located in the device (e.g. in relation to the processor or in the sensor) or alternatively in an external device (e.g. a server, home/office management system, a bridge), or in a remote device (such as a remote server accessible via a network or via the Internet). Said processor may also be part of a processing unit with multiple processors. Said processor may also be divided into multiple smaller processing units.

Navigation and positioning may also relate to navigation and positioning within a virtual, gamified, or augmented reality. Hence, in an embodiment, the first application related to the group of mapping, positioning and navigation comprises navigation and/or positioning within a virtual, gamified, or augmented reality. For example, the first application may comprise a navigation application wherein navigation is provided within a virtual world. Movements may be obtained by real movement data, real navigation data or acceleration data. The virtual world may be a game or an augmented reality. The second application may subsequently provide a complementary function other than related to the group of mapping, positioning and navigation, like for example a shopping application for buying game credits, a tutorial application explaining a gamified environment, or a group application in which multiple apps are grouped for selection.

Said first application related to the group of mapping, positioning and navigation may be enabled by different technologies. Hence, in an embodiment, the first application related to the group of mapping, positioning and navigation is functionally enabled by GPS, Bluetooth, Wi-Fi, Visible Light Communication, IR, RF or magnetic field fingerprinting. Said techniques enabling the application related to the group of mapping, positioning and navigation may be suitable for both indoor as well as outdoor mapping, positioning and navigation. Combinations of techniques may also be possible, for example: Bluetooth navigation complemented with VLC; or VLC navigation complemented with GPS when suitable light sources are temporarily absent; or GPS based navigation complemented with Wi-Fi for indoor positioning when GPS is not able to reach indoors.

Indoor navigation or positioning may be performed in an indoor space, for example a shop, shopping mall, an airport, cruise ship, etc. The navigation or positioning may, for example, show a layout of a shop and present the position and heading of a user. The navigation or positioning may also, for example, indicate a path to a particular product or space and provide a user with navigation or positioning information.

As mentioned before, it may be advantageous that the first application comprises an application related to the group of mapping, positioning and navigation, while the second application comprises another application, such that both applications are added value to one another. In an embodiment, the second application comprises an application related to advertisement, social media, photography, point of sales, connectivity, or remote control; or to energy management of the device during active operation. As these applications provide complementary functions with respect to the application related to the group of mapping, positioning and navigation, it is advantageous to have a second application related to advertisement, social media, photography, point of sales, or remote control; or to energy management of the device during active operation. Advertisement may include apps related to shopping or a shop catalogue. Advertisement may also include online marketing, providing messages tailored to a user, or location based advertisement services. The application social media may include the functions of posting messages, connecting to social media profiles or subscribing to (local) events. The application photography may include video, augmented reality or image processing. Point of sales may include the functions of payment, selecting payment methods, shop checkout and point saving schemes. The application of remote control may be related to accessing local devices, commissioning of devices or systems, or obtaining access. The application related to connectivity may include the activation of chipsets enabling wireless connection, the search for an availability of wireless (network) connections, or the establishment of a wireless connection or wireless communication, which may for example include the establishment of a secure VPN network.

An advantageous second application may also be related to the energy management of the device during active operation, because the orientation of the device may be utilized to manage the energy properties of the device. Energy management may include apps for providing information on the energy usage of the device, or providing information related to the energy usage of the application related to the group of mapping, positioning and navigation, as this may consume additional power due to an active mapping, positioning and/or navigation hardware. Energy management may also include a standby function, an energy saving function, an active change in energy usage by the device, or the limitation of power provided to parts of hardware.

The selection of the second application may be based on external sources. Hence, in an embodiment, the device further comprises a communication unit for communicating with a central server; wherein the processor is arranged for selecting the second application based on information received from the central server. The central server may be located in the device (e.g. in relation to the processor), wherein it may also serve as a hosting server for other devices, wherein other devices are connectable to this server. The central server may also be located externally, wherein the central server may be arranged in a remote device, such as a remote server accessible via a network or via the Internet. The remote device may also be included in a bridge which is accessible via ZigBee, Wi-Fi, NFC or Bluetooth connection. An advantage of such a device according to the invention, wherein the second application is selected by the processor based on information received from a central server, is that it will enable external sources to provide improved and more suited applications. For example, a central server hosted by a retailer may provide a user, which is using the device according to the invention within a venue of the retailer, with the most recent information on the venue by means of a customized retail application.

It may furthermore be beneficial to select the second application based on information provided by other users having a similar device according to the invention, because it will enable the sharing of information, such that an improved device behavior is provided. Thus, in an embodiment, the device further comprises a communication unit for communicating with at least a second device according to the invention; wherein the processor is arranged for selecting the second application based on information received from the at least second device. Said means to communicate may be by Wi-Fi, NFC, Bluetooth, ZigBee, GSM, IR, or visible light communication. The at least second device may be a device according to the present invention. For example, in case a user uses a device according to the invention, and the majority of other devices according to the invention within a certain area use a weather application as second application, the weather application may be selected as the second application of said device.

In another embodiment, the device further comprises a communication unit for communicating with at least a second device; wherein the processor is arranged for selecting the second application based on information received from the at least second device. Hence, the at least second device does not have to be a device according to the invention, but may also be a different device. This is advantageous, because devices different to the present invention may still hold information, which is relevant to select a second application more suited for use in located based services. For example, a connected smart light pole (which comprises presence detection data) may provide a device according to the invention with traffic data (e.g. showing traffic congestions) by allowing the processor to temporarily select a traffic application as second application while navigating through a city by means of the first application related to the group of mapping, positioning and navigation.

In an embodiment, the second application provides a function related to a location determined within the first application. For example, the second application may comprise an app that is related to a venue A, which will be implemented whenever the device is located at venue A or is navigating towards venue A, which will be determined by a positioning function of the first application related to the group of mapping, positioning and navigation. This is advantageous, because a more suitable second application may be set depending on the location of the device, e.g. at different venues.

In an embodiment, the processor is arranged for selecting the second application by entering the device in a location determinable within the first application, wherein said selection of the second application is undoable when the device leaves said location. For example, the processor may automatically select an application related to a venue A, by replacing an application Z, when the device is entering a venue A. Venue A may be e.g. a shop, festival, a public building, shopping mall, airport, harbor, warehouse, border, parking spot or hospital. When the device is leaving venue A, the processor may undo the selection of application A and select application Z again as the second application. This provides an automatic adjustment of applications based on location, which will serve the user.

In an embodiment, the sensor may be a gyroscope, an accelerometer, gravity sensor or a magnetometer. A gyroscope, accelerometer gravity sensor or magnetometer are relatively small sensing devices with sufficient accuracy to sense orientation. These sensors are therefore suitable and widely implemented in many smart electronic devices. It is thus advantageous to use said sensors to sense an orientation of the device according to the present invention. In another embodiment, the sensor may be a camera or a proximity sensor. Although these sensors are indirectly deriving the orientation of the device, they may advantageously provide additional information on the surroundings of the device. Yet in another embodiment, the sensor may be separate from a main body of the device, but able to communicate the orientation of the device back to the main body of the device. Such embodiment may be advantageous to reduce hardware in the main body of the device. For example, a camera in a venue may sense an orientation of a device (or multiple devices simultaneously) by taking an image, performing image-processing to find the orientation of the device(s) and communicating said orientation back to the main body of the device, such that a first or second application may be implemented.

The device according to the invention may also comprise additional means to output information related to an application. In an embodiment, said display may comprise at least two displays for outputting information. This will enable the device to output information of applications on different screens, which improves the functionality of the device. For example, in case of a device with a front face and a back face, a first display may be on a front face of a device, while a second display may be on the back face of a device. In another embodiment, the device further comprises a loudspeaker, a light source, or an internal vibrator for outputting information.

In some cases it may be advantageous to have the ability to adjust the implementation of the second application, while being in second orientation. This means partly adjusting the implementation, i.e. adjusting only a set of functions of the second application, or fully adjusting the second application. It will add a functionality to the device according to the invention. Hence, in an embodiment, the device further comprises a detector for detecting an input signal and providing a detector output; wherein the processor is arranged for adjusting the second application based on information provided in the detector output. For example, suppose a device is navigating through a shop by means of a (first) navigation application, a second application may then be a point of sale application in which a user may pay with a discount for products encountered at a location in the shop. The user will navigate in the shop by holding the device horizontal, while buying discounted product by holding the device vertical. In case the discount is over, a signal may be send by Bluetooth to the detector (Bluetooth antenna) of the device, such that the second application will either be fully suppressed based on information provided in the detector output, or partly adjusted by only suppressing the payment function of the second application.

Said detector may be related to a group of detectors. Hence, in an embodiment, said detector may be selected from the group consisting of a camera, a light diode, a proximity sensor, a temperature sensor, a touchpad or button for detecting inputs, a pressure sensor, a GPS receiver, radio detector, Wi-Fi receiver, ZigBee receiver, Bluetooth antenna, NFC chip, a biosensor, a detector for detecting physiological properties of a person, magnetic field sensor or a microphone. Said detectors may be able to provide information, which is relevant to the device, for adjusting the second application. For example: a touchpad or button may be used to detect user input, which may subsequently be processed by the processor to suppress the second application whenever the user does not desire the second application temporarily; or, a temperature sensor may be used to determine the intensity of incident rays of light (for example from the sun) in order to adjust a backlighting function of a second application, such that the device will also have an improved second application; or, a heartbeat sensor may be processing the physiological properties of a person which uses the device for navigating during running, and when the heartbeat goes beyond a threshold value, the device may adjust the second application partly with another user interface indicating the high heartbeat (when in second orientation).

The detector may also be a combination of detectors. The detector will then output a detector output with information related to the information obtained from the combination of detectors. In an embodiment, the detector comprises at least a first and second detector for providing a detector output, wherein the detector output based on information obtained from at least two detectors. Having a detector comprising of multiple detectors may adjust or suppress the implementation of the second application by assessing on a broader range of information.

The invention further relates to a method for location based services. It is another object of the invention to provide an improved method for located based services. Such a method may provide different applications next to an application related to the group of mapping, positioning and navigation depending on the orientation of the device.

Thereto, a method for location based services comprises displaying information; sensing an orientation of the device; running a first application when the device is in a first orientation; running a second application when the device is in a second orientation; wherein, the device is in the first orientation if the display is within 30 degrees of a plane perpendicular to gravity, the device is in the second orientation if the display is within 30 degrees of a plane parallel to gravity; outputting an application related to the group of mapping, positioning and navigation on the display when the device is in the first orientation; outputting an application other than the first on the display when the device is in the second orientation; switching from said application related to the group of mapping, positioning and navigation to said application other than the first by moving the device from first orientation to the second orientation; and/or switching from said application other than the first to said application related to the group of mapping, positioning and navigation by moving the device from second orientation to the first orientation.

An advantage of such a method is that an improved method is provided for positioning, because the orientation of the device specifies said first application (i.e. navigation) at the first orientation (horizontal), which is ergonomically more suited orientation for positioning, while the second (i.e. other than positioning) application of the device is specified at the second orientation, which is less-suited for positioning. As a result, an improved method is provided for positioning, wherein the device is able to switch between applications based on the orientation of the device.

In an embodiment, said methods for location based services may particularly be implemented for positioning and/or navigation, it is thus provided: a method for location based services according to the method mentioned before, wherein the application related to the group of mapping, positioning and navigation provides a functionality for positioning and/or navigation based on GPS, Bluetooth, Wi-Fi, Visible Light Communication, IR, RF or magnetic field fingerprinting.

The invention further relates to a computer program product. Hence, the invention provides computer program product for a computing device, the computer program product comprising computer program code to perform the abovementioned methods for positioning and/or navigation when the computer program product is run on a processing unit of the computing device. Said computer program product may be executed by the processor of the device according to the invention. For example, said processing unit of the computing device may be the processor of the device according to the invention. Performing abovementioned method by means of the computer program product may include only the features of the method implementable by means of a computer program product.

Thus, aspects of the invention may be implemented in a computer program product, which may be a collection of computer program instructions stored on a computer readable storage device which may be executed by a computer. The instructions of the present invention may be in any interpretable or executable code mechanism, including but not limited to scripts, interpretable programs, dynamic link libraries (DLLs) or Java classes. The instructions can be provided as complete executable programs, partial executable programs, as modifications to existing programs (e.g. updates) or extensions for existing programs (e.g. plugins). Moreover, parts of the processing of the present invention may be distributed over multiple computers or processors.

Storage media suitable for storing computer program instructions include all forms of nonvolatile memory, including but not limited to EPROM, EEPROM and flash memory devices, magnetic disks such as the internal and external hard disk drives, removable disks and CD-ROM disks. The computer program product may be distributed on such a storage medium, or may be offered for download through HTTP, FTP, email or through a server connected to a network such as the Internet.

In an embodiment, a computer program product may be provided to the device according to the invention by means of visible light communication. Said computer program product may be the computer program product according to the present invention. For example, a computer program product may be stored on a server which controls light sources in a positioning system based on visible light communication. The computer program product may then be uploaded to a device making use of the indoor positioning system by means of the visible light communication already active for positioning. Downloading and uploading information by means of visible light communication provides an advantage, because a relevant computer program product may be simultaneously uploaded by means of the infrastructure already present. In another but similar embodiment, the computer program product may be downloadable to a device by means of Bluetooth, VLC or Wi-Fi from respectively a Bluetooth, VLC or Wi-Fi navigation system. Downloadable may also imply uploadable.

### BRIEF DESCRIPTION OF THE DRAWINGS

The invention will now be further elucidated by means of the schematic non-limiting drawings:

FIG. 1A & FIG. 1B depict schematically, in a scheme and in perspective view respectively, an embodiment of a device for location based services, comprising a sensor, a processor, a first application and a second application;

FIG. 2A & FIG. 2B depict schematically, embodiments of a device for location based services, comprising a sensor, a processor, a first application and a second application, which has means to communicate with other devices; a central server in FIG. 2A, other devices according to the invention and other smart-devices in FIG. 2B;

FIG. 2C depicts schematically an embodiment of a device for location based services, comprising a sensor, a processor, a first application and a second application, and additionally a detector;

FIG. 2D depicts schematically an embodiment of a device for location based services, comprising a sensor, a processor, a first application and a second application, and additionally a camera arranged for visible light communication; and

FIG. 3 depicts schematically a method for positioning according to the invention.

### DETAILED DESCRIPTION OF THE EMBODIMENTS

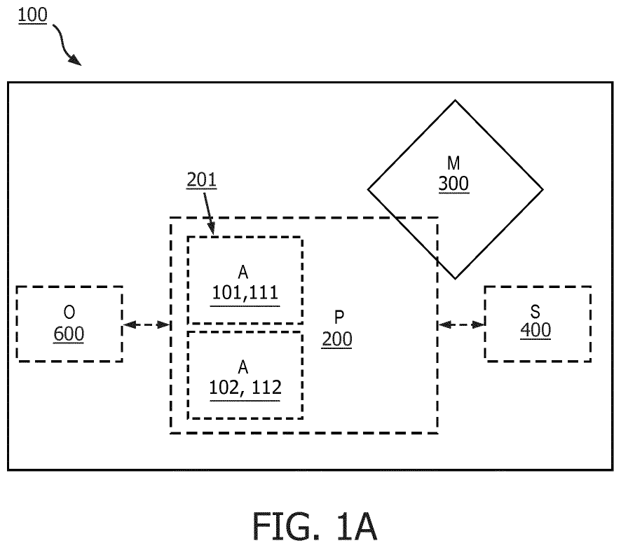

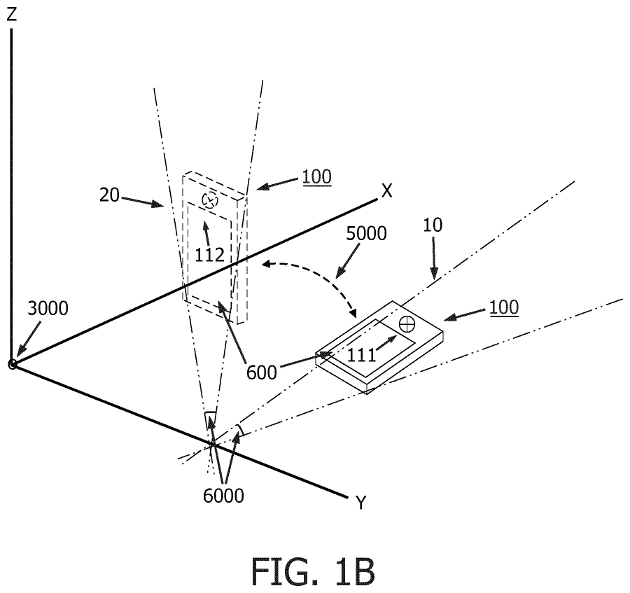

FIGS. 1A and 1B depict schematically, by non-limiting example, an embodiment of a device 100 for location based services comprising: a sensor 400 for sensing an orientation of the device 100; a processor 200 for enabling applications 201; a first application 101 and a second application 102; a display 600 for outputting information. Said embodiment is depicted in a diagram in FIG. 1A and in perspective in FIG. 1B.

The processor 200 enables applications 201, amongst which the first application 101 and the second application 102. The first application 101 comprises a navigation application 111. The navigation application 111 is enabled by GPS and is able to provide positioning as well, i.e. locating a device on a map based on GPS data. The navigation application 111 may comprise, and is not limited to, the functions of routing, voice-control, location tagging, mapping, or a user interface tailored for navigation within a certain venue. Alternatively, said first application 101, i.e. here the navigation application 111, may be enabled by Bluetooth, Wi-Fi, Visible Light Communication (VLC), IR or RF technology, or combinations thereof.

The second application 102 comprises an application other than the first (related to the group of mapping, positioning and navigation). In said embodiment, the second application 102 comprises a shopping application 112, which is able to provide an advertisement function, provide a function to check-out with a payment, and provide customized discounts. The second application may adjust its content depending on a store wherein the device 100 is present. Hence, the second application 102 provides functions within the shopping application 112 which may be related to a location determined within the navigation application 111. For example, whenever the device 100 is located at a venue A or is navigating towards a venue A, information is provided to the processor 200, such that the navigation application 111 will provide a present location and the shopping application 112 may be adjusting its content thereon. Alternatively, the shopping application 112 may be automatically selected when the device is entering venue A and the selection may be undone when the device is leaving venue A. Here, selecting means not implementing the application, but reserving the selection and implementing the application when tilted to the second orientation. Furthermore, in alternative embodiments, the second application 102 may not have to be related to a location determined within the first application 101. Alternatively, the second application 102 may also be related to advertisement, social media, photography, point of sales, connectivity, or remote control; or to energy management of the device 100 during active operation. In other alternative embodiments, the second application 102 may be: a social media application which enables users to post pictures and tag it to a location by efficiently bringing the device 100 from the first 10 to the second orientation 20. In another embodiment the second application 102 may be a payment applications for parking wherein the payment function is implemented by tilting the device 100 to second orientation 20 at a parking location determined by a first application 101 being a positioning application based e.g. on VLC. In another embodiment the second application 102 may be a connectivity application which searches for connectable devices in the neighborhood of the device 100 when the device 100 is tilted to second orientation 20.

In an alternative embodiment, the navigation application 111 may comprise navigation and/or positioning within a virtual, gamified, or augmented reality. For example, the first application 101 may comprise a navigation application 111 wherein navigation is provided within a virtual world of a game. The user may navigate through the virtual gamified world based on the movements and physical navigation signals provided in the real world. Such movements may be obtained by navigation data based on GPS, VLC, Bluetooth or Wi-Fi, or position and acceleration data of the device 100. The virtual world may be a game or an augmented reality. The second application may subsequently provide a complementary function other than related to the group of mapping, positioning and navigation, like for example a shopping application for buying game credits or a group application in which multiple apps are grouped for selection.

Still referring to the embodiment depicted in FIG. 1A-1B, a memory 300 is located in the device 100 in relation to the processor 200. The processor 200 is arranged for accessing the memory 300 for storing and retrieving information. Alternatively, the memory 300 may be arranged in relation to the sensor 400; or in an external device for example a server, home/office management system, a bridge. Alternatively or additionally, the memory may be present in a remote device such as a remote server accessible via a network or via the Internet.

Still referring to the embodiment depicted in FIG. 1A-1B, the first application 101 (i.e. navigation application 111) and the second application 102 (i.e. shopping application 112) are ‘apps’ which are downloaded and stored on the memory 300 of the device 100. The navigation 111 and shopping application 112 operate in accordance with a part of hardware of the device 100, such as the processor 200 and for example a GPS or Wi-Fi receiver (not shown). As mentioned before, both apps may comprise multiple functionalities.

Still referring to the embodiment depicted in FIG. 1A-1B, the sensor 400 is a gyroscope, which senses the orientation of the device 100 and provides the processor 200 with the orientation information. Alternatively, the sensor 400 may be an accelerometer, gravity sensor, a magnetometer, or a combination thereof. The sensor may be a camera or a proximity sensor, which derives the orientation of the device 100 indirectly. The orientation of the device 100 is communicated by the sensor 400 to the processor 200 by a hard wired connection. Alternatively, the sensor 400 may be separate from the main body of the device 100, but still able to communicate the orientation of the device 100 back to the main body of the device 100; like for example a camera detecting the orientation of the device 100 from an external location and communicating this information back to the device 100 via a wireless connection.

Still referring to the embodiment depicted in FIG. 1A-1B, the display 600 outputs information related to the applications 201, 101, 111, 102, 112. This may for example be a user interface related to the shopping application 112 or the navigation application 111. The display 600 is an AMOLED display. Alternatively, the display may be a LCD, CRT, OLED, super AMOLED, Retina display, a touchscreen, a 3-D screen or a holographic display. Furthermore, display 600 is a single display, but alternatively may comprise at least two displays for outputting information. Even further, outputting information may also alternatively be provided by means of a mechanical vibrator (not shown) or by means of a light source (not shown), which respectively vibrates or emits light (or modulated light) to indicate a signal.

Still referring to the embodiment depicted in FIG. 1A-1B, a device 100 according to the invention is depicted in perspective view in FIG. 1B. Said device 100 has a display 600 suitable for use in location based services. Alternatively, the device 100 may be applied as part of or within a tablet, a wearable device, smart glasses, navigation device, visualization screens, remote controls, or a multimedia device.

Referring to the embodiment in FIG. 1B, a Cartesian X-Y-Z coordinate system 3000 is defined in FIG. 1B with the Z-axis in the gravitational direction; i.e. the negative Z direction points downwards to the center of gravity. The device 100 is oriented within this coordinate system 3000. The first application 101, which is the navigation application 111, is implemented when the device 100 is in the first orientation 10. The first orientation 10 is a plane defined by the X and Y-axis of the coordinate system 3000, i.e. perpendicular (horizontal) with respect to gravity, e.g. 0 degrees (of rotation) with respect to X and Y-axis. The second application 102, namely the shopping application 112, which is an application other than the first application 101 related to the group of mapping, positioning and navigation, is implemented when the device 100 is in second orientation 20. The second orientation 20 is a plane defined by the Z and Y-axis of the coordinate system 3000, i.e. vertical with respect to gravity, e.g. 90 (of rotation) degrees with respect to Y-axis. Furthermore, the first orientation 10 and the second orientation 20 comprise a rotational tolerance 6000 of thirty degrees with respect to the horizontal (X-Y plane) and vertical (Z-axis). Alternatively, said rotational freedom 6000 with respect to the Y-axis may be twenty degrees at most and ten degrees at least; or ten degrees at most and five degrees at least; or at most five degrees.

Referring to the embodiment depicted FIG. 1A-1B, the device 100 is used for navigating through a venue by means of implementing the navigation application 111 as the first application 101 within the first orientation 10. The user interface shown on display 600 will be a map of the venue for use in navigation. Alternatively, other user interfaces for navigation, like showing directions may be displayed on display 600. Whenever the device 100 is moved into the second orientation 20 by a tilting motion 5000, the second application 102 is implemented and outputted on display 600, which is the shopping application 112. The functions of the second application 112 can be used in said second orientation 20. The shopping application 112 complements the navigation application 111, because the location of the device 100 determined with the navigation application 111 specifies which products are available for shopping. Alternatively, the location of the device 100 may be used to provide a payment function or an advertisement function within the shopping application 112. The device 100 implements the first application 101, which is the navigation application 111, when moved again into the first orientation 10 by a tilting motion 5000.

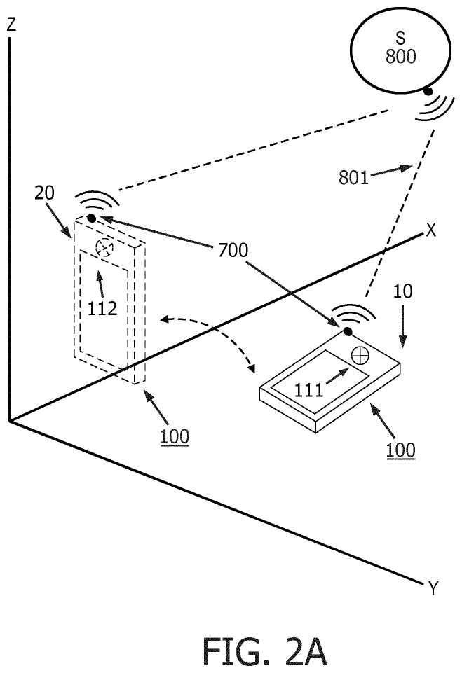

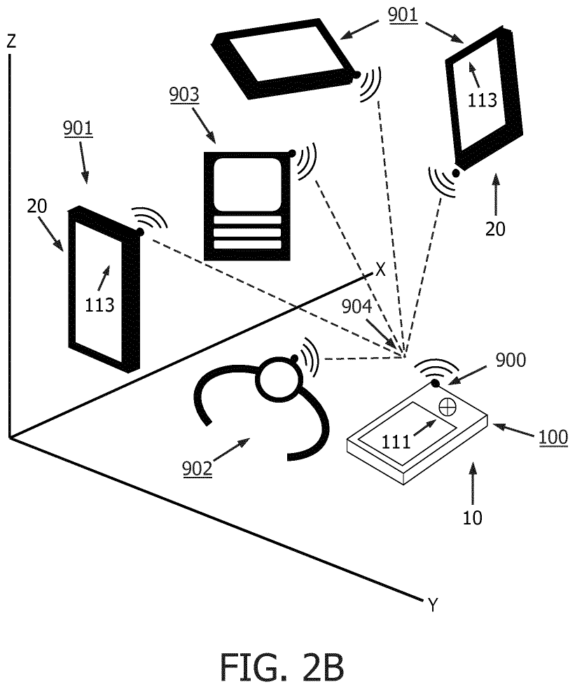

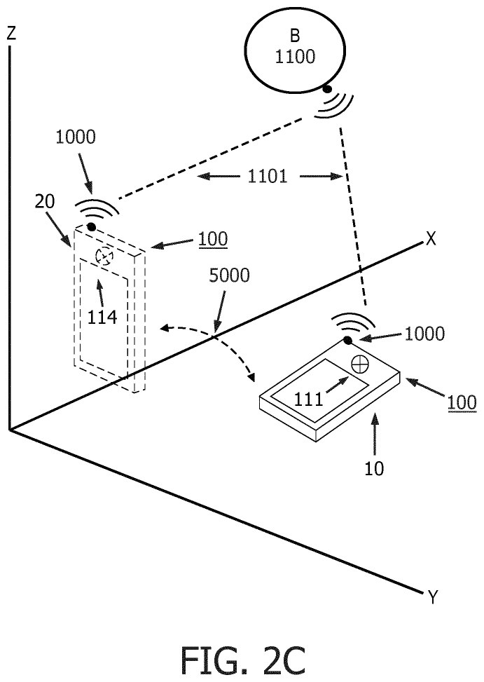

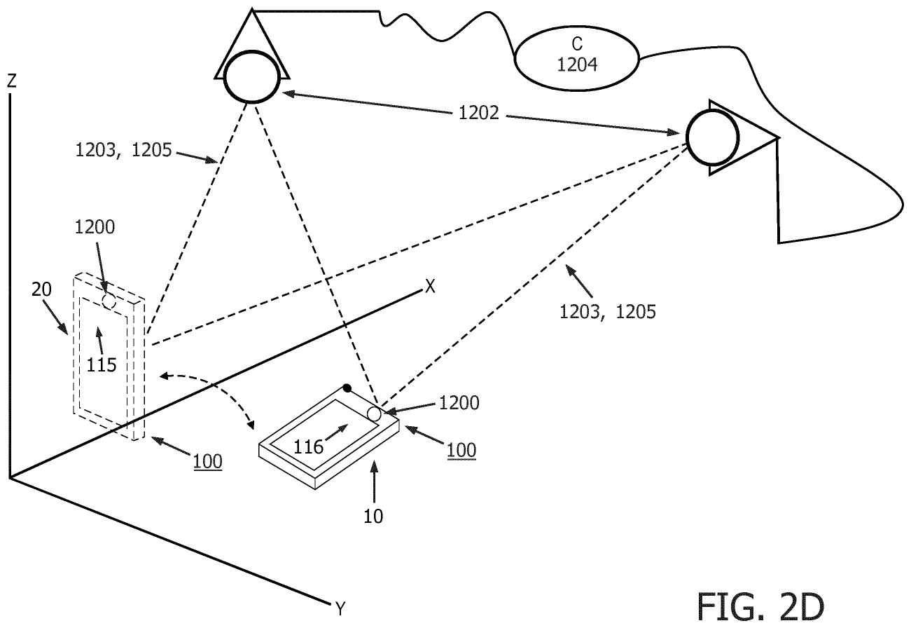

FIG. 2A depicts schematically, by non-limiting example, an embodiment of a device 100 for location based services, which is partly similar to the embodiment in FIG. 1A-1B, but additionally comprises a Wi-Fi connection 700 to communicate with a central server 800. Said Wi-Fi connection 700 may alternatively be a connection by means of Bluetooth, ZigBee, GSM, IR, or visible light communication.

The device 100 is in communication with a central server 800 by means of a Wi-Fi connection 700. The central server 800 is a separate device. However, the central server 800 may alternatively be located within another device according to the invention in relation to the processor, such that it can serve as a hosting server for the device 100 and more other devices according to the invention; or the central server 800 may be located in another remote device which is accessible by the device 100 and devices according to the invention, for example a bridge. In said embodiment, the central server 800 is providing the device 100 with information 801 related to the shop, wherein the device 100 is navigating by means of the navigation application 111 in first orientation 10. Said information 801 may comprise an incentive or command to use a shopping application 112 as the second application. The processor of the device 100 will process said information 801 and select the shopping application 112 as the second application. The shopping application 112 will already be present on the device 100, for example in relation to the processor and/or the memory. Alternatively, the shopping application may be downloaded from, or uploaded by, the central server 800 onto the device 100: for example an updated version of the shopping application 112. Said information 801 will not only be used for selecting or providing the second application, but part of the information may also be used within the second application, e.g. to keep the content of the shopping application 112 up to date.

FIG. 2B depicts schematically, by non-limiting example, an embodiment of a device 100 for use in positioning and/or navigation, which is partly similar to the embodiment in FIG. 1A-1B, but additionally comprises a ZigBee connection 900 to communicate with other devices according to the invention 901 and other smart-devices like a smartwatch 902 or notebook 903. Said ZigBee connection 900 may alternatively be a connection by means of Bluetooth, Wi-Fi, GSM, IR, or visible light communication. Said other smart-devices 902, 903 may alternatively be a computer, wearables, smart kitchen appliances, media devices.

The device 100 is in communication with three other devices according to the invention 901 and a smartwatch 902 and a notebook 903. The processor of device 100 is able to select the second application based on information 904 received from the other devices according to the invention 901 and the other smart-devices (i.e. smartwatch 902 and notebook 903). To be more specific: the device 100 is navigating by means of the navigation application 111 in first orientation 10. Said other devices according to the invention 901, which are in ZigBee range of the device 100, are implementing a weather application 113 as the second application 113 in second orientation 20. This information is communicated by said devices 901 to the device 100. Similarly, the other smart-devices, i.e. the smartwatch 902 or notebook 903 may detect humidity and light intensity by their own means and provide the device 100 with information about the humidity and light intensity in the environment. The processor will then process all the information 904 that is received and select a weather application 113 as the second application, because the conditions in the environment may indicate that it is beneficial to implement a weather application as the second application. It will add complementary value to the first navigation application 111, because it may rain on the route the device 100 is taking by means of the navigation application 111.

FIG. 2C depicts schematically, by non-limiting example, an embodiment of a device 100 for location based services, which is partly similar to the embodiment in FIG. 1A-1B, but additionally comprising a Bluetooth detector 1000 (i.e. Bluetooth antenna) for detecting input signals and providing a detector output to the processor. Said Bluetooth detector 1000 may alternatively be a detector selected from the group consisting of a camera, a light diode, a proximity sensor, a temperature sensor, a touchpad or button for detecting inputs, a pressure sensor, a GPS receiver, radio detector, Wi-Fi receiver, ZigBee receiver, Bluetooth antenna, NFC chip, a biosensor, a detector for detecting physiological properties of a person, magnetic field sensor or a microphone. Alternatively, said detector may also be a combination of detectors.

Referring to the embodiment depicted in FIG. 2C, the device 100 is used for navigation through a warehouse in which wholesale products are auctioned. Navigation is provided by the navigation application 111 in the first orientation 10, while a shopping/auctioning application 114 is implemented in the second orientation 20 as the second application. A person using the device 100 will be able to navigate to a wholesale product in the warehouse and place an order (auction, buy, sell, etc.) by switching 5000 the orientation of the device 100 from first orientation 10 to the second orientation 20 such that the shopping/auctioning application 114 (comprising the desired functionalities) is implemented. Some users may be temporarily prohibited to buy a product, or may temporarily not be given a discount for a certain product. In such cases, a signal may be send by a Bluetooth beacon 1100 to the Bluetooth antenna 1000 of the device 100, such that the second application (i.e. the shopping/auctioning application 114) will either be fully suppressed based on the information provided in the signal 1101, or partly suppressed by only adjusting the payment function of the second application. Alternatively, the user may provide an input signal to the device 100, such that he can opt not to implement (i.e. to suppress) the second application of the device 100. Such an input signal may be provided by a pressure sensor (e.g. pressing a button). Alternatively, the shopping/auctioning application and the navigation application may be part of a single more comprehensive application, for example a warehouse application which comprises both applications, or the functionalities of both applications. The first application in first orientation may then be the navigation application of the warehouse application, while the second application in second orientation may then be the shopping/auctioning application of the warehouse application.

FIG. 2D depicts schematically, by non-limiting example, an embodiment of a device 100 for location based services, which is partly similar to the embodiment in FIG. 1A-1B, but additionally comprises a frontend camera 1200 and backend camera (not shown) arranged for visible light communication (VLC). The device 100 is able to provide positioning based on visible light communication with light sources 1202 in a shop. The position of the device 100 is determined by means of identifying unique identifiers in the modulated light signals from the light sources 1202 and matching these with a predefined ‘light source map’ within a positioning application 116 on the device 100. When the user enters the shop, the camera 1200 on the device 100 will recognize the emitted visible light 1203 from the light sources with their unique identifier and the processor will select the second application as an advertisement application 115 specific to said shop. When the device 100 is in first orientation 10, the positioning application 116 is implemented. When the device 100 is in second orientation 20, the advertisement application 115 is implemented. This advertisement application 115 may provide the user with product information and current discounts. While the user locates oneself within the shop with the positioning application 116, the advertisement application 115 is used for checking possible discounts at that location. Alternatively, the advertisement application 115 may comprise a photography function to capture images, for example of barcodes to determine price or photographs to upload onto a social media page of a brand to join a competition. In case the advertisement application 115 is not present on the device 100 and the processor is unable to select it, the processor may use the visible light communication infrastructure to download the advertisement application 115 on the device 100. That is: the light sources 1202 are controlled by a computing unit 1204, which is able to modulate the light of the light sources 1202 in order to send visible light data 1205 for installing the advertisement application 115. Alternatively, the camera may be a light diode.

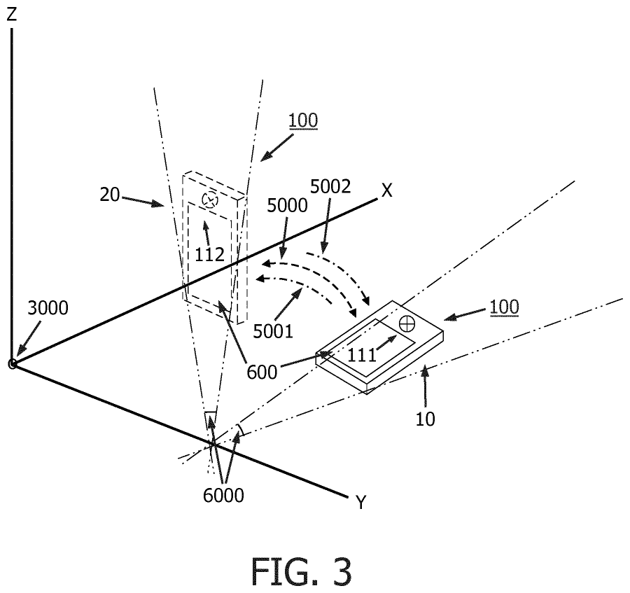

FIG. 3 depicts schematically, by non-limiting example, a method for location based services, comprising:

displaying information on the display 600; sensing an orientation 10, 20 of the device 100; running a first application 111 when the device 100 is in a first orientation 10; running a second application 112 when the device 100 is in a second orientation 20; wherein, the device 100 is in the first orientation 10 if the display 600 is within thirty degrees of a plane perpendicular to gravity, the device 100 is in the second orientation 20 if the display 600 is within thirty degrees of a plane parallel to gravity. Thus, a rotational tolerance 6000 of thirty degrees exists with respect to the ‘horizontal’ and ‘vertical’ in a Cartesian coordinate system 3000 with the Z-axis in gravitational direction. The method further comprises, outputting an application 111 related to the group of mapping, positioning and navigation on the display 600 when the device 100 is in the first orientation 10; outputting an application 112 other than the first on the display 600 when the device 100 is in the second orientation 20; switching 5000 from said application 111 related to the group of mapping, positioning and navigation to said application 112 other than the first by moving 5001 the device 100 from first orientation 10 to the second orientation 20; and/or switching 5000 from said application 112 other than the first to said application 111 related to the group of mapping, positioning and navigation by moving 5002 the device 100 from first orientation 20 to the first orientation 10.

Alternatively, said first application may be a mapping or navigation application, for example based on GPS, Bluetooth, Wi-Fi, Visible Light Communication, IR, RF or magnetic field fingerprinting; and the second application may an application related to advertisement, social media, photography, point of sales, connectivity, or remote control; or to energy management of the device during active operation.

1. A device for location based services comprising:
a sensor for sensing an orientation of the device;
a processor for receiving the orientation of the device and for running a first application related to the group of mapping, positioning and navigation and a second application other than the first application;
a display for displaying output of applications;
wherein the processor is arranged for running the first application when the device is in a first orientation and the second application when the device is in a second orientation;
and wherein,
the device is in the first orientation if the display is within 30 degrees of a plane perpendicular to gravity,
the device is in the second orientation if the display is within 30 degrees of a plane parallel to gravity.

2. The device according to claim 1, wherein the second application comprises an application related to advertisement, social media, photography, point of sales, connectivity, or remote control; or to energy management of the device during active operation.

3. The device according to claim 1, wherein the first application related to the group of mapping, positioning and navigation is functionally enabled by GPS, Bluetooth, Wi-Fi, Visible Light Communication, IR, RF or magnetic field fingerprinting.

4. The device according to claim 1, wherein the device further comprises a communication unit for communicating with a central server;
wherein the processor is arranged for selecting the second application based on information received from the central server.

5. The device according to claim 1, wherein the device further comprises a communication unit for communicating with at least a second device according to any one of the preceding claims;
wherein the processor is arranged for selecting the second application based on information received from the at least second device.

6. The device according to claim 1, wherein the sensor is a gyroscope, an accelerometer, gravity sensor or a magnetometer.

7. The device according to claim 1, wherein the second application provides a function related to a location determined within the first application.

8. The device according to claim 1, wherein the device further comprises a detector for detecting an input signal and providing a detector output; wherein the processor is arranged for adjusting the second application based on information provided in the detector output.

9. The device according to claim 8, wherein the detector is a camera, a light diode, a proximity sensor, a temperature sensor, a button for detecting inputs, a pressure sensor, a GPS receiver, radio detector, Wi-Fi receiver, ZigBee receiver, Bluetooth antenna, NFC chip, a biosensor, a detector for detecting physiological properties of a person, magnetic field sensor or a microphone.

10. The device according to claim 1, wherein the processor is arranged for selecting the second application by entering the device in a location determinable within the first application, wherein said selection of the second application is undoable when the device leaves said location.

11. The device according to claim 1, wherein the first application related to the group of mapping, positioning and navigation comprises navigation and/or positioning within a virtual, gamified, or augmented reality.

12. A method for location based services comprising:
displaying information;
sensing an orientation of the device;
running a first application when the device is in a first orientation;
running a second application when the device is in a second orientation;
wherein,
the device is in the first orientation if the display is within 30 degrees of a plane perpendicular to gravity,
the device is in the second orientation if the display is within 30 degrees of a plane parallel to gravity.
outputting an application related to the group of mapping, positioning and navigation on the display when the device is in the first orientation;
outputting an application other than the first on the display when the device is in the second orientation;
switching from said application related to the group of mapping, positioning and navigation to said application other than the first by moving the device from first orientation to the second orientation; and/or
switching from said application other than the first to said application related to the group of mapping, positioning and navigation by moving the device from second orientation to the first orientation.

13. The method according to claim 12, wherein the application related to the group of mapping, positioning and navigation provides a functionality for positioning and/or navigation based on GPS, Bluetooth, Wi-Fi, Visible Light Communication, IR, RF or magnetic field fingerprinting.

14. A computer program product for a computing device, the computer program product comprising computer program code to perform the method of claim 12 when the computer program product is run on a processing unit of the computing device.

15. The computer program product for a computing device according to claim 14, wherein the computer program product is downloadable to a device by means of Bluetooth, VLC or Wi-Fi from respectively a Bluetooth, VLC or Wi-Fi navigation system.
